(19) United States
(12) Patent Application Publication
(10) Pub. No.: US 2024/0110065 A1
(43) Pub. Date: Apr. 4, 2024

(54) PRODUCTION OF CARBON BLACK

(71) Applicant: Green Lizard Technologies Ltd., Belfast (GB)

(72) Inventor: Martin Atkins, Belfast (GB)

(21) Appl. No.: 18/270,175

(22) PCT Filed: Dec. 21, 2021
(86) PCT No.: PCT/EP2021/087894

§ 371 Date: Jun. 28, 2023

(30) Foreign Application Priority Data
Dec. 31, 2020 (GB) 2020931.8

(51) Int. Cl. C09C 1/48

(52) U.S. Cl. CPC C09C 1/487; C01P 2006/12; C01P 2006/14; C01P 2006/80

(57) ABSTRACT

The present invention relates to a process for the production of carbon black from a plastic pyrolytic char. In particular, the process comprises pre-washing the plastic pyrolytic char followed by washing with acid and then base.

### FIELD OF INVENTION

The present invention relates to a process for the production of carbon black from a plastic pyrolytic char. In particular, the process comprises pre-washing the plastic pyrolytic char followed by washing with acid and then base.

### BACKGROUND

Plastics are one of the most commonly used materials due to their cheap price and versatility. They are often produced for single-use purposes and making up about 10% of the commercial and household waste produced.

Plastic waste poses a unique challenge as it is not bio-degradable and can persist in the environment for centuries if it is not disposed of using a suitable method. The current widely used methods to handle plastic wastes includes landfilling, incineration and recycling. Most plastic wastes end up in landfills as current recycling and incineration facility capacity is small compared to landfill capacity. This does not align with the current drive towards increased recycling and the use of environmental process.

Incineration returns some of the energy stored in the plastics in the form of heat energy that can be used to generate steam which can be used to produce electricity. One of the biggest disadvantages of the incineration process is production of carcinogenic furans and dioxins emissions. Another disadvantage of the incineration process is the form of product. Incineration produces heat, which can only be utilized in nearby regions as it loses its energy when transported through long distances.

Plastic wastes can also be recycled to produce new plastics, recovering the plastic material which can be used to produce new plastic products. However, plastic recycling requires time and labour-intensive collection as well as separation, causing the process to have a low technical and economic feasibility. Plastic separation is difficult and cross contaminations are almost always inevitable, producing recycled products that can only be used in low grade applications. Intensive washing is also required before recycling processes take place, producing further waste.

Plastic pyrolysis is one of the most promising plastic disposal methods as it recovers energy from waste plastics in gaseous, liquid and solid form while emitting minimal pollutants. Pyrolysis is the thermal decomposition of materials at elevated temperatures in the absence of oxygen. Thus, no combustion or oxidation takes place. In plastic pyrolysis, the plastic wastes are heated to a temperature such as 500 to 800° C. to degrade the wastes into combustible gases, liquid and solid products.

Pyrolysis is a tertiary recycling process that is currently considered as a superior way to recover energy from plastic wastes or to produce useful products such as energy sources and chemical feedstock. Compared to incineration, pyrolysis produces fewer toxic gases as well as having a higher energy recovery efficiency. Pyrolysis products are also much more flexible and easy to transport compared to heat energy, which is produced during incineration.

Pyrolysis is also more feasible than plastic recycling as it is not sensitive to cross plastic contaminations, and therefore does not require an intense separating process. It is considered as a promising green technology as even its gaseous by-product has a significant calorific value that can be reused in the pyrolysis stage to decrease the energy requirement for the pyrolysis plant.

Factors that affect different product yields and the composition of products include the operating temperature, heat rate, retention time, feedstock composition and the use of catalyst. Pyrolysis conditions can be tuned to optimize the product yield desired.

Char is the solid residue produced after the pyrolysis of a certain feedstock. Char produced from the thermal conversion of carbonaceous feedstock generally contains a blend of carbon blacks, ash, organic and inorganic compounds. The properties of char depend on the feed composition as well as the pyrolysis process conditions. Much attention has been paid to oil and gas products obtained from fast pyrolysis, however little attention has been given to the char product, its properties, how pyrolysis conditions affects its properties and its use.

For example, the char produced from the pyrolysis of plastics (termed “plastic pyrolytic char” herein) will differ significantly from the char produced from tyres (termed “tyre pyrolytic char” herein), which already include carbon black as an additive in about 30 to 35% of the total tyre weight in addition to rubbers and other chemicals. For instance, tyre pyrolytic char has a high char yield of tyre pyrolysis, typically around 40 to 50% of the total pyrolytic product mass. Conversely, char makes up only 10 to 20% of the total plastic pyrolysis products.

Crude plastic pyrolytic char has very limited applications and very low market value, about $45/tonne, as a low-grade fuel. This is due to the crude char's high contaminant content, with crude char typically comprising carbon black, plastic additives, carbonaceous deposits, non-volatile hydrocarbons and ash. The heavy metals and organic compounds present in the ash content are toxic. Thus, ash is an important contaminant as it decreases the value of plastic pyrolysis char radically due to its toxic nature.

Char can be upgraded into useful carbonaceous products such as carbon black, activated carbon, soil conditioner and coal. Because pyrolytic char generally contains a large amount of contaminants, there are large upgrading limits. The extent of upgrading depends on the final applications.

Carbon black is an additive used primarily in rubber products, especially tyres, to improve their physical and chemical properties. Carbon black is characterized by a high carbon content such as above 85 wt % and low impurity content. Carbon black differs from other carbonaceous materials such as soot and char as these materials have a higher content of contaminants and impurities

The furnace black process produces over 95% of the total world production of carbon black. It uses heavy petroleum oil as feedstock where it is heated at extremely high temperatures in a closed reactor to atomize the feedstock under controlled temperature and pressure. The carbon black produced is cooled and collected in bag filters in a continuous process.

The second most used process for commercial carbon black production is the thermal black process. Together with the furnace black process, these processes produce nearly all of the world's carbon black. The thermal black process primarily uses natural gas or heavy petroleum oil as feedstock. The resulting carbon black can be further processed to decrease impurity content.

These traditional carbon black production are processes require 2 tonnes of heavy oil as feedstock for every tonne of carbon black produced, producing 10 tonnes of CO₂ as by-product. Therefore, repurposing pyrolytic char as carbon black offers a sustainable alternative to virgin carbon black production which can reduce the amount of greenhouse gasses produced.

Carbon black production from tyre pyrolytic char has been studied due to the high char yield of tyre pyrolysis as well as the large amount of carbon black already present in tyres, which leads to a high level of carbon black in the tyre pyrolytic char. However, there has been little research on the production of carbon blacks using plastic pyrolytic char due to its lower production rate and lower content of carbon black.

The carbon black present in pyrolytic char can be recovered by removing the organic and inorganic compounds. It is known that organic components that are non-polar or have low polarities can be removed with an organic solvent wash. For example, organic solvents like hexane and acetone have been used to remove pyrolysis tar from the char sample. However, inorganic contaminants such as metal compounds and silicon compounds cannot be removed effectively in this way.

Consecutive pyrolysis treatment of pyrolytic char has also been suggested. However, such treatment temperatures are too low to effectively evaporate the ash and sulphur compounds.

The recovery of carbon black from tyre pyrolytic char using acid-base demineralization has been studied and reported in literature. However, due to the differences in composition between these char types, processing conditions used for alternative tyre types cannot be directly transferred to plastic pyrolytic char.

The use of highly available materials such as plastic wastes as a precursor to carbon black and activated carbon can improve the overall sustainability of the product. In addition, the repurposing of plastic pyrolytic char could have significant implications on the overall economic and commercial viability of the plastic pyrolysis process, thus improving the recycling of waste plastics and preventing their accumulation in landfill.

Thus, it is desirable to develop efficient processes for obtaining carbon black from char produced from plastic pyrolysis.

### SUMMARY OF THE INVENTION

It has surprisingly been found that carbon black having high carbon content and low metal content may be produced from plastic pyrolytic char through a process comprising pre-washing combined with acid and base washing.

Accordingly, the present invention provides a process for producing carbon black comprising:
a) pyrolising a plastic feed comprising polyethene (PE) or polypropylene (PP), or combinations thereof, to produce a plastic pyrolytic char;
b) pre-washing the plastic pyrolytic char with an aqueous solution;
c) washing the pre-washed plastic pyrolytic char with acid; and
d) washing the acid-washed plastic pyrolytic char with base.

In another aspect there is provided carbon black produced by the process disclosed herein.

Also provided is the use of a PP, PE, or combinations thereof, feed in the production of carbon black, and the use of pyrolytic char formed from PP, PE, or combinations thereof in the production of carbon black.

It will be appreciated that the ability to efficiently obtain carbon black from a PP, PE, or combinations thereof, feed reduces CO₂ production from alternative methods of forming carbon black and recycles plastics rather than sending them to landfill. Moreover, the process uses PP, PE, or combinations thereof, pyrolytic char which is not commonly used and thus would usually go to waste. Moreover, the carbon black produced has been found to be of sufficient quality that it can be sold as carbon black without further processing.

For reference, unless otherwise specified or it is obvious that a contrary meaning is intended, all percentages referring to concentrations in the present application are percentage by weight (wt %).

The process for producing carbon black comprises: pyrolysing a plastic feed comprising PP, PE, or combinations thereof to produce a plastic pyrolytic char; pre-washing the plastic pyrolytic char with an aqueous solution; washing the pre-washed plastic pyrolytic char with acid; and washing the acid-washed plastic pyrolytic char with base.

This process may also be used as a pre-treatment before activation for activated carbon production.

### Plastic Feed

As noted above, plastics feed comprises PP, PE, or combinations thereof. Sources of such waste materials include bags, bottles, films, sheets, fibres, textiles, pipes and other moulded or extruded forms.

The types of PP and PE used in such materials may include low density and high density materials, such as LDPE (low density PE), LLDPE (linear low density PE), UHMWPE (ultrahigh-molecular-weight PE), XLPE (cross-linked PE) and HDPE (high density PE), as well as isotactic, syndiotactic and atactic forms, such as iPP, sPP and aPP.

Such plastics do not usually comprise significant amounts of carbon black.

Thus, the plastic feed of the present invention preferably comprises less than 20 wt %, preferably less than 10 wt %, more preferably less than 5 wt % and even more preferably is substantially free from carbon black. By substantially free it is intended to mean that, carbon black is present in amounts of less than 3 wt % preferably less than 1 wt %, and more preferably less than 0.1 wt % (and even less than 0.01 wt %, or 0.005 wt %.

It will be appreciated that the char is the solid residue produced after the pyrolysis of the feed, but not all feeds will produce char in useable amounts. The properties of the char are dependent on the feed composition. Therefore, the feed also determines the further processing conditions required to process the char produced such as removal impurities. For this reason, further processing conditions, such as washing, used on one type of char produced from a certain feed type, such as tyres, cannot be automatically transferred to the processing of a char produced from plastics such as PP, PE, or combinations thereof.

High-density polyethylene (HDPE), low-density polyethylene (LDPE) and polypropylene (PP) make up 60 to 70% of municipal solid waste and have surprisingly been found to be suitable for producing good quality carbon black using the method described herein.

Preferably, the PP, PE, or combinations thereof makes up at least 50 wt % of the plastic feed, preferably at least 60 wt %, more preferably at least 70 wt %, even more preferably at least 80 wt % and most preferably at least 85 wt %. The plastic feed may also be comprised of at least 90 wt. %, preferably at least 95 wt. % and potentially higher such as 98 wt. % of PP, PE, or combinations thereof.

LDPE and HDPE are both polymers of ethylene and have the formula (CH₂CH₂)ₙ. The properties of polyethylene and thus its classification as LDPE or HDPE and its applications depend on factors such as molecular weight, branching and density. LDPE preferably has a molecular weight of from 30,000 to 50,000 g/mol and a density of from 0.910 to 0.925 g/cm³. HDPE preferably has a molecular weight of from 200,000 to 500,000 g/mol and a density of from 0.941 to 0.980 g/cm³. LDPE preferably has branching on from 1 to 4% of carbon atoms, more preferably on 1 to 3% of carbon atoms, more preferably on 1.5 to 2.5 of carbon atoms. HDPE preferably has less branching than LDPE, such as on less than 2% of carbon atoms, preferably less than 1% of carbon atoms, more preferably less than 0.5% of carbon atoms, even more preferably less than 0.1% of carbon atoms. As LDPE generally has more branching than HDPE, the intermolecular forces between the chains are weaker, its tensile strength is lower, and its resilience is higher than HDPE. In contrast, HDPE is known for its high strength-to-density ratio. HDPE is commonly used in the production of many items, including plastic bags, plastic bottles, piping and containers. LDPE is commonly used in parts that require flexibility, such as snap on lids, in trays and containers, and in plastic wraps.

PP is a polymer of propylene and has the formula (CH(CH₃)CH₂)ₙ. Preferably, the density of PP is between 0.895 and 0.92 g/cm³. PP may have a melting point of from 130° C. to 170° C., depending on its tacticity. In general, the properties of PP may be considered to be similar to polyethylene, however the methyl group improves mechanical properties and thermal resistance. Generally, PP is tough and flexible with good resistance to fatigue. Therefore, PP may be used in hinges. PP may also be used in applications requiring high temperatures, such as in medical applications which require the use of an autoclave or kettles.

In addition, polyethylene (PE) and PP may be copolymerised with other monomers. The monomers selected will depend on the required properties. For example, PE may be copolymerised with vinyl acetate or with an acrylate. These copolymers may be used in athletic-shoe sole foams and in packaging and sporting goods respectively. In particular, PE and PP maybe copolymerised. For example, a random copolymer of PP with PE may be used for plastic pipework.

Preferably, the plastic feed comprises low amounts of plastics which have a low char yield, such as polyethylene terephthalate (PET) and polyvinyl chloride (PVC) which produce mainly gases. These plastics are preferably present in the plastic feed in amounts of less than 30 wt %, preferably less than 15 wt %, more preferably less than 10 wt %. Where sorting of waste plastics is particularly efficient, such plastics may be present in amounts in less than 5 wt %, such as less than 1 wt % and even less than 0.5 to 0.1 wt %.

Polyvinyl chlorides (PVCs) are polymers comprising chlorine. The main product of PVC pyrolysis is hydrochloric acid (HCl), with a low oil and char yield. The toxic and corrosive nature of HCl poses a negative impact to the environment and human health in addition to damaging process equipment. For these reasons, it is particularly preferred that PVC not be used in pyrolysis, or only be used in low amounts. Such small amounts are ideally less than 0.1 wt %, preferably less than 0.07 wt %, more preferably less than 0.05 wt % polyvinyl chloride (PVC).

For the process of the present invention however, it has surprisingly been found that a small amount of PVC may be used in the plastic feed. By way of example, the plastic feed may comprise at least 0.005 wt %, preferably at least 0.01 wt %, more preferably at least 0.02 wt %, most preferably at least 0.03 wt % polyvinyl chloride (PVC). Without being bound by theory, the HCl produced from PVC during pyrolysis is believed to cause some degree of chemical activation during the pyrolysis process as HCl is an effective activating agent. Activation is intended to mean that the surface area of the product is increased

Increasing the plastic pyrolytic char surface area in this way decreases the extent of activation needed in any subsequent upgrading process, for example to activated carbon. However, additional precautions may be needed to process HCl at higher concentrations due to its corrosive nature.

The plastic feed may be processed prior to pyrolysis to change the shape and/or size of the plastic, for example by extruding, chopping and/or shredding. The plastic feed may be in the form of pellets, flakes, threads or fibres, films or may be shredded. Preferably, the plastic feed is processed to increase the surface area. Without being bound by theory, this is believed to result in more efficient pyrolysis of the plastic feed.

Prior to pyrolysis, the plastic feed may be extruded, for example by melting the plastic feed followed by extrusion. This may be performed in a melt extruder. The melt extruder may heat the plastic feed to a temperature of 200 to 400° C., preferably 250 to 350° C., more preferably 265 to 325° C. Preferably, the extruded product is chopped prior to pyrolysis. Without being bound by theory, this is believed to provide a greater surface area available for pyrolysis.

Calcium oxide may be added to the plastic feed material in order to remove hydrochloric acid which may be present/formed during the process. Calcium oxide may be added in an amount of from 1 wt % to 5 wt %, preferably 2 wt % to 4 wt %, more preferably 2.5 wt % to 3.5 wt % with respect to the plastic feed. Calcium oxide is preferably added to the plastic feed prior to pyrolysis, such as before it is fed to the pyrolysis vessel. For example, calcium oxide may be added to the plastic feed in the melt extruder.

There is provided herein the use of a feed comprising PP, PE, or combinations thereof in the production of carbon black. Such uses may comprise the process described herein.

### Pyrolysis

The pyrolysis may be performed using any suitable method, of which the skilled person would be aware, and is performed by heating the sample in the absence of oxygen. The pyrolysis is preferably performed under an inert atmosphere, such as nitrogen or argon, preferably nitrogen.

Prior to pyrolysis, the plastic feed may be melted. This may be performed heating the plastic feed to a temperature of 200 to 400° C., preferably 250 to 350° C., more preferably 265 to 325° C.

The plastic feed may be heated to a temperature of from 300 to 1000° C., preferably 350 to 900° C., more preferably 390 to 700° C. during pyrolysis.

Pyrolysis may be performed for from 30 min to 48 hours, preferably 1 hour to 24 hours, more preferably 5 to 12 hours.

The plastic feed may be heated during pyrolysis at a rate of 2° C. min⁻¹ to 80° C. min⁻¹, preferably from 3° C. min⁻¹ to 50° C. min⁻¹, more preferably 5° C. min⁻¹ to 20° C. min⁻¹.

Pyrolysis may be performed in a pyrolysis vessel, such as a fixed bed reactor or a rotary kiln. The pyrolysis vessel may have one or more separate temperature zones, such as two to five separate temperature zones.

If one temperature zone is used, a fixed bed reactor is preferably used. Where one temperature zone is used, the pyrolysis vessel is preferably operated at a temperature of from 350° C. to 700° C., preferably 450° C. to 600° C. A fixed bed reactor is preferably operated at a temperature of from 350° C. to 700° C., preferably 450° C. to 600° C. It has been found that pyrolysis of a plastic feed under these conditions results in char in acceptable yields.

If more than one separate temperature zone is used, the pyrolysis vessel is preferably a rotary kiln. Where a series of separate temperature zones is used, the temperature is preferably increased as the sample passes from zone to zone. By way of example, the sample may be heated to a temperature of from 350° C. to 480° C., preferably 390° C. to 460° C., in the first temperature zone and the temperature may be increased to a temperature of from 490° C. to 700° C., preferably 500° C. to 660° C. in the final temperature zone. For example, in a pyrolysis vessel comprising a series of four separate temperature zones: the first temperature zone may be at a temperature of from 350° C. to 480° C., preferably 390° C. to 460° C.; the second temperature zone may be at a temperature of from 460° C. to 500° C., preferably 470° C. to 490° C.; the third temperature zone may be at a temperature of from 490° C. to 520° C., preferably 500° C. to 515° C.; and the fourth temperature zone may be at a temperature of from 500° C. to 700° C., preferably 510° C. to 680° C., more preferably 520° C. to 660° C. The pyrolysis vessel is preferably maintained under an inert atmosphere, preferably nitrogen.

The pyrolysis vessel may be operated at atmospheric pressure (1 atm), which is approximately 101 kPa. Preferably, the rotary kiln is maintained at a slight negative pressure, such as less than 50 kPa, preferably less than 10 kPa, more preferably less than 0.1 kPa, most preferably less than 0.01 kPa.

The products from pyrolysis may include condensable, non-condensable and solid hydrocarbons. The condensable hydrocarbon products may include synthetic petroleum and a variety of its fractions including but not limited to light sweet crude oil, fuel additives, base oil, slack wax, paraffin wax, microcrystalline wax and condensate dominated by aromatic petroleum hydrocarbons. The non-condensable hydrocarbon product may be a gas. The solid hydrocarbon product comprises char.

The pyrolysis process may further comprise separating the char from the other pyrolysis products. The products of the pyrolysis vessel may be separated by means of a standard fractionation column. Alternatively, solid char may be separated from the other products by sedimentation, filtration or other suitable methods. The non-condensable material may be a C1 to C3 gas which may be recycled to provide heating to the kiln.

Char may be produced in an amount of from 1 wt % to 20 wt %, preferably 3 to 16 wt %, preferably 6 to 13 wt % of the total pyrolysis product.

The char produced using such methods from a feed as described herein (PP, PE or combinations thereof) generally comprises 40 to 50 wt % of carbon and may be processed as described herein to produce carbon black.

“Plastic pyrolytic char” as used herein is intended to mean char obtained from the pyrolysis of PP, PE or combinations thereof. The plastic feed as defined herein is distinct from tyre pyrolytic char which is typically formed from rubbers and comprises carbon black as an additive in about 30 to 35% of the total tyre weight.

There is provided herein the use of pyrolytic char formed from PP, PE or combinations thereof in the production of carbon black.

Surprisingly, it has been found that pre-washing plastic pyrolytic char obtained from a plastic feed comprising PP, PE or combinations thereof followed by acid and base washing results in carbon black with improved properties. In particular, the combination of these washing steps has been shown to significantly increase carbon content, and aid in the removal of ash such as metals.

Each washing step will be described below in turn, however it is the combination of these washing steps which results in the surprising increase in carbon content in combination with the reduction in ash content in the resulting carbon black.

By way of example, it has surprisingly been found that the process is able to remove impurities which other prior art processes, such as those only comprising acid or base washes have been unable to remove.

By way of further example, it has surprisingly been found that the process is able to remove impurities such as ash and sulphuric content present in the char, when compared to known prior art processes. It has additionally been found that the process increases the surface area of the carbon black. It has further been found that acids with a higher concentration, used in combination with the other process steps, result in a higher surface area and pore volume in the resulting product.

Even still further, the removal of impurities, such as by demineralization is improved using the present process.

### Pre-Washing

Pre-washing is performed with an aqueous solution, and may be water. The solution may comprise further solvents and/or solutes. Preferably, the solution has a pH within the range to 8.

The pre-washing may be performed at a temperature of from 5 to 50° C., preferably from to 40° C., and more preferably from 15 to 30° C. It will be appreciated that the temperature used may, in part, be selected according to the solvent used.

Preferably, pre-washing is performed for a duration of 10 minutes to 3 hours, preferably 30 minutes to 2 hours, more preferably 45 minutes to 1.5 hours.

The pre-washing may comprise a drying step. Any suitable drying method may be used, such as air drying, oven drying, optionally under vacuum, vacuum drying, lyophilisation or using a desiccator, optionally under vacuum. Preferably, the sample may be dried using an oven. Drying may be performed for 30 minutes to 48 hours, preferably 1 hour to 24 hours, more preferably 5 hours to 12 hours.

Agglomeration of char particles to form coarser particle sizes has been found to occur after the washing and drying step during pre-washing. It has been found that the increase in char particle sizes may in some instances decrease the effectiveness of the subsequent washing with acid and/or base due to the decreased available surface area of the char particles. In particular, it is believed that the structure of the char such as the shape, porosity and surface area effects the of accessibility of the impurities in the char to the acid or base solution and thus affects the leaching process, as discussed further hereinbelow. Therefore, preferably the pre-washed char is further processed before further washing steps are performed in order to reduce the particle size. This may be performed by any suitable method, such as by way of example grinding or sieving.]

### Acid Washing

Acid washing is preferably performed by an acid solution, such as an aqueous acidic solution. Preferably the pH of the solution is from −1 to 5, preferably 0 to 4.

Preferably the acid is a strong acid, which is intended to mean that it completely dissociates in water. Examples of suitable strong acids include hydrochloric acid (HCl), hydrobromic acid (HBr), hydroiodic acid (HI), nitric acid (HNO₃), perchloric acid (HClO₄), chloric acid (HClO₃), triflic acid (HCF₃CO₃) and sulfuric acid (H₂SO₄). The acid may comprise more than one acidic species. Preferably, the acid may be selected from HCl, HNO₃, H₂SO₄ and combinations thereof. Preferably, the acid is HCl.

Preferably, the acid solution has a concentration of 10 to 95 wt. %, preferably 30 to 80 wt. %, more preferably 35 to 65 wt %.

Where it is desirable to further increase the surface area of the carbon black to be produced, an acid concentration of from 50 to 90 wt %, preferably 60 to 85 wt %, may be used. However, alternatively milder reaction conditions may be desirable so that specialist equipment is not required and/or to reduce the safety risks associated with washing. Therefore, a lower concentration of acid may be used in these circumstances. By way of example, an acid concentration of from 10 wt % to 50 wt %, preferably 30 to 40 wt % may be used, whilst still ensuring an increase in surface area and effective washing.

The acid may be added in a weight ratio of acid to char of from 0.1:1 to 4:1, preferably 0.5:1 to 3:1, more preferably 1:1 to 2:1. Preferably, the acid is present in excess with respect to the char, such that the weight ratio of acid to char is greater than 1:1, such as 1.1:1. Thus, the acid is preferably added in a weight ratio of acid to char of from 1.1:1 to 4:1, preferably 1.1:1 to 3:1, more preferably 1.1:1 to 2:1. For the avoidance of doubt, if an acid has a concentration other than 100 wt %, this ratio is based on the actual amount of acid added, rather than the amount of acid solution added. Therefore, if a 37 wt % solution were to be added in an amount of 4 times the weight of char, the ratio of acid:char will be 1.48:1.

Acid washing may be performed at temperatures above 20° C. Preferably, washing is performed at a temperature of from 30 to 150° C., preferably from 60 to 130° C., more preferably from 90 to 110° C.

Acid washing is preferably performed for less than 24 hours, preferably less than 12 hours, more preferably less than 6 hours. Preferably, acid washing is performed for a duration of 10 minutes to 3 hours, preferably 30 minutes to 2 hours, more preferably 45 minutes to 1.5 hours.

Preferably mild reaction conditions are used during acid washing, such as low temperatures of 150° C. or below, short reaction times of less than 24 hours, and an acid concentration of below 50 wt %, as these conditions decrease the complexity of the process, as well as reducing associated risks. Such conditions may also be advantageous when scaling up the process.

Acid washing is performed by combining the acid solution and char. This mixture may be agitated, such as by stirring or other suitable means such as sonication, for the desired time, optionally with heating. Increasing the agitation intensity improves the turn-over rate of leaching agent on the char surfaces and improves the mass transfer rate as well as heat transfer rate of the process. Therefore, washing is preferably performed with agitation.

Following washing, the acid solution may be removed from the char. This may be done by any suitable method, such as filtration or centrifugation followed by removal of any remaining acid solution from the char.

Following removal of the acid solution, the char may be washed with water. This may be done by the addition of water, optionally with agitation, followed by removing the liquid from the char, such as by filtration or centrifugation or using any other suitable method.

The acid-washed char may then be dried. This may be performed using the methods described for the pre-washing step and/or for the durations described for the pre-washing step.

As described for the pre-washing step, the char may have agglomerated during acid washing. Therefore, the acid-washed char may be further processed in order to reduce the particle size. This may be performed by any suitable method, as described above for the pre-washing step.

### Base Washing

Base washing is preferably performed by a base solution. Preferably, the base is an aqueous basic solution. Preferably the pH of the solution is from 8 to 15, preferably 9 to 14.

Preferably the base is a strong base, which is intended to mean that it completely dissociates in water. Examples of suitable strong bases include hydroxides of alkali metals and alkaline earth metals, such as lithium hydroxide (LiOH), sodium hydroxide (NaOH), potassium hydroxide (KOH), rubidium hydroxide (RbOH) and cesium hydroxide (CsOH). The base may comprise more than one basic species. Preferably, the base may be selected from NaOH or KOH and combinations thereof. Preferably, the base is NaOH.

It has surprisingly been found that bases with a higher base dissociation constant result in improved removal of metal impurities, and thus ash removal, and a higher carbon content.

Preferably, the base solution has a concentration of 10 to 95 wt. %, preferably 30 to 90 wt. %.

The base may be present in a weight ratio of base to char of from 0.1:1 to 4:1, preferably 0.5:1 to 3:1, more preferably 1:1 to 2:1. Preferably, the base is present in excess with respect to the char, such that the weight ratio of base to char is greater than 1:1, such as 1.1:1. Thus, the base is preferably added in a weight ratio of base to char of from 1.1:1 to 4:1, preferably 1.1:1 to 3:1, more preferably 1.1:1 to 2:1. For the avoidance of doubt, if a base has a concentration other than 100 wt %, this ratio is based on the actual amount of base added, rather than the amount of base solution added. Therefore, if a 37 wt % solution were to be added in an amount of 4 times the weight of char, the ratio of base:char will be 1.48:1.

Base washing may be performed at temperatures above 20° C. Preferably, washing is performed at a temperature of from 30 to 150° C., preferably from 60 to 130° C., more preferably from 90 to 110° C.

The base washing is preferably performed for less than 24 hours, preferably less than 12 hours, more preferably less than 6 hours. Preferably, base washing is performed for a duration of 10 minutes to 3 hours, preferably 30 minutes to 2 hours, more preferably 45 minutes to 1.5 hours.

Preferably mild reaction conditions are used for base washing, such as low temperatures of 150° C. or below, short reaction times of less than 24 hours, and a base concentration of below 50 wt %, as these conditions decrease the complexity of the process, as well as reducing associated risks. Such conditions may also be advantageous when scaling up the process.

Base washing is performed by combining the base solution and char. This mixture may be agitated, such as by stirring or other suitable means such as sonication, for the desired time, optionally with heating. Increasing the agitation intensity improves the turn-over rate of leaching agent on the char surfaces and improves the mass transfer rate as well as heat transfer rate of the process. Therefore, washing is preferably performed with agitation.

Following washing, the base solution may be removed from the char. This may be done by any suitable method, such as filtration or centrifugation followed by removal of any remaining base solution from the char.

Following removal of the base solution, the char may be washed with water. This may be done by the addition of water, optionally with agitation, followed by removing the liquid from the char, such as by filtration or centrifugation or using any other suitable method.

The base-washed char may be dried. This may be performed using the methods described for the pre-washing step and/or for the durations described for the pre-washing step.

As described for the pre-washing step, the char may have agglomerated during base washing. Therefore, the base-washed char may be further processed in order to reduce the particle size. This may be performed by any suitable method, as described above for the pre-washing step. This may help to increase the BET surface area of the resulting carbon black.

### Further Pyrolysis

The production of carbon black may comprise further pyrolyzing the char either during the washing process described herein or following the washing process. For example, pyrolysis may be performed following the acid wash. Additionally, or alternatively, pyrolysis may be performed following the washing process (WABW) described herein. It has been found that such pyrolysis can result in a higher surface area and pore volume in the resulting carbon black. However, it is not considered that such a step is essential.

Pyrolysis may be performed as described above in the pyrolysis of a plastic feed.

### Carbon Black

The carbon content and ash content are some of the most strictly regulated properties in commercial grade carbon blacks and these are therefore used as benchmark targets.

Ash is a general umbrella term that includes metal compounds and minerals, mainly metal oxides and silicon compounds

Carbon black preferably has the following properties:
Carbon content of 85 wt. % or over
Ash content of below 2 wt. %

Preferably the carbon black formed in the process described herein achieves one or both of these values such that it can be used in place of carbon black currently available, and produced using traditional means.

The carbon content of carbon black may be measured using standard techniques, which would be known to the skilled person. In general, methods involve oxidation of the carbon in the sample to form carbon dioxide (CO₂), followed by measuring the amount of CO₂ produced. Oxidation may be performed by high temperature combustion, high temperature catalytic oxidation, photo-oxidation, thermo-chemical oxidation, photo-chemical oxidation, or electrolytic oxidation. For example, the sample may be oxidised by complete combustion of the sample in a carbon-free atmosphere. Preferably, the atmosphere is an oxygen atmosphere. The amount of carbon in the sample is then determined by measuring the amount of CO₂ produced. The amount of CO₂ may be quantified by performing infrared (IR) measurements, in particular by measuring the intensity of the C═O stretch at 2350 cm⁻¹, as the intensity of the stretch is proportional to the amount of CO₂ present. This may be performed using a non-dispersive infrared detection cell. Prior to oxidation of the sample, the sample may be acidified to transform inorganic carbon, generally in the form of carbonate and bicarbonate, into CO₂. The CO₂ released during acidification may be measured and added to the amount of CO₂ produced by oxidation. However, preferably, this CO₂ produced by oxidation, in addition to other gases produced, are vented away prior to oxidation.

Preferably, the carbon black comprises at least 70 wt % carbon, preferably at least 75 wt % carbon, more preferably at least 80 wt % carbon and even more preferably at least 85 wt % carbon. Preferably, the carbon black produced has a high carbon purity of at least 85 wt % so that it can replace currently available carbon blacks produced using less green methods.

It has surprisingly been found that the combination of pre-washing, acid washing and base washing is much more effective at removing impurities from plastic pyrolysis char than acid or base treatments in isolation acid or base treatments with pre-washing. In particular, it has been surprisingly found that the combination of pre-washing with acid and base washing (WABW) results in a carbon content of over 87 wt %, which is significantly higher than the carbon content obtained using other washing methods. This demonstrates the surprising effectiveness of the washing method described herein.

It has also been found that the use of bases with a high base dissociation constant results in a greater the increase carbon content. Thus, bases with a high base dissociation content, such as NaOH, are particularly effective in the washing process of the present invention.

Moreover, the implementation of further processing steps, such as the inclusion of grinding between washing steps, will increase the carbon content even further as this will improve the effectiveness of the leaching process. The inclusion of additional pyrolysis steps during or after washing can also be used to further improve the properties of the carbon black obtained. In particular, pyrolysis has been found to increase the surface area and pore volume of the carbon black obtained following washing.

Preferably, the carbon black has an ash content below 5 wt %, preferably below 3 wt %, more preferably below 2 wt %, further preferably below 1 wt % and even more preferably below 0.5%. Such low ash contents allows the carbon black of the present invention to replace known commercial carbon blacks produced using less green methods.

As ash present in char compounds is mainly made up of metal and silicon compounds, a decrease in the content of these compounds in the char samples reflects a decrease in ash content. In particular, metal content in char is often used in literature to study the effectiveness of demineralization processes, as demonstrated in Chaala, A., Darmstadt, H. and Roy, C., 1996. “Acid-base method for the demineralization of pyrolytic carbon black”. Fuel Processing Technology, 46(1), pp. 1 to 15.

The metal content may be determined using atomic adsorption spectrometry (AAS), more specifically Flame Atomic Adsorption Spectrometry (FAAS). AAS metal content analyses may be performed using a Perkin Elmer Analyst 100. The AAS analysis method may have a sensitivity of up to 1 part per million. Flame Atomic Adsorption Spectrometry (FAAS) uses air, acetylene or a nitrous oxide flame to atomize the sample to a maximum temperature of 2600° C. FAAS's precision typically falls below 10%.

Preferably, the carbon black has a total metal content of below 50,000 mg/kg, preferably below 20,000 mg/kg, more preferably below 15,000 mg/kg.

Surprisingly, it has been found that pre-washing in combination with acid and base washing is the most effective for increasing the carbon content in combination with reducing the ash and metal content.

As noted above, agglomeration may occur between washing steps, which increases the particle size. Without being bound by theory, this is believed to result in poorer leaching in latter washing steps. Thus, the particle size is preferably reduced between one or more washing steps, such as following pre-washing and/or following acid washing and/or following base washing. This may be performed by grinding. Preferably, the char particle size is maintained at a similar size throughout each processing step to prevent the detrimental effects of agglomeration and achieve efficient leaching of impurities.

### Surface Area and Pore Volume

Commercial carbon blacks have specified surface area and particle sizes for different grades, with surface areas between 60 to 120 m²/g considered as ideal for tyre additive purposes.

Preferably, the carbon black has a surface area of from 20 to 200 m²/g, preferably from 40 to 150 m²/g, more preferably from 60 to 120 m²/g.

Preferably, the carbon black has a pore volume of at least 0.06 cm³/g, preferably at least 0.9 cm³/g, more preferably at least 0.13 cm³/g, even more preferably at least 0.16 cm³/g. Preferably the carbon black has a pore volume of up to 2 cm³/g, preferably up to 1 cm³/g, more preferably up to 0.5 cm³/g, even more preferably up to 0.3 cm³/g.

The surface area, pore volume and pore size may be measured using Brunauer-Emmett-Teller (BET) theory. BET theory generally uses probing gases that do not chemically react with the material surface as adsorbates to quantify specific surface area. Generally, the specific surface area of the material may be determined by physical adsorption of the gas on the surface of the solid, measuring the amount of adsorbed gas, and calculating the surface area assuming a monomolecular layer of gas on the surface. Gas adsorption also enables the determination of the size and volume of pores. Preferably, nitrogen is employed as the gaseous adsorbate. If nitrogen is used, BET analysis is preferably conducted at the boiling temperature of N₂ (77 K, −196.15° C.). Methods of performing BET analysis to obtain the surface area, pore volume and pore size of a sample would be known to the skilled person. Preferably the method used complies with Ph. Eu.2.9.26 Method II. For example, BET analysis may be performed on a Micromeritics Gemini 2375 and Gemini V.

Although the process of the present invention is primarily used for contaminant removal purposes, it has surprisingly been shown to also cause some degree of activation, despite the low temperatures and mild conditions used, which are not representative of the conditions used during typical activation processes. For example, known chemical activation methods that use acidic and basic activating agent are usually activated at temperatures above 450° C. Therefore, process according to the present invention may also be used to produce carbon black with an increased pore volume and surface area when compared to the crude char but without the requirement of temperatures above 450° C.

Carbon black produced using the washing method described herein may be used in the production of activated carbon. This is particularly beneficial as this carbon black requires less upgrading to achieve the desired surface area than carbon blacks having a lower surface area produced using other methods.

### Activated Carbon

Carbon black produced according to the process described herein is particularly suitable for forming activated carbon because it has high purity and may also have a larger surface area and pore volume when compared to crude char, or samples purified using alternative techniques. This means that the further activation required is less extensive.

Thus, the process described herein may also be used as a pre-treatment before activation to produce activated carbon. Thus, the plastic feed may also be used in the production of activated carbon. Additionally, plastic pyrolytic char may be used in the production of activated carbon.

Therefore, the process for producing activated carbon comprises all of the above steps, plus activation to produce activated carbon.

Activation is intended to mean that the surface area of the product, in this instance activated carbon, is increased relative to the starting material, in this instance carbon black.

Activation may be performed by any suitable means. Methods of activating carbon black to form activated carbon would be known to the skilled person.

The present invention is further described by way of the following Examples, which are provided for illustrative purposes and are not in any way intended to limit the scope of the invention as claimed, and with reference to the following figures in which:

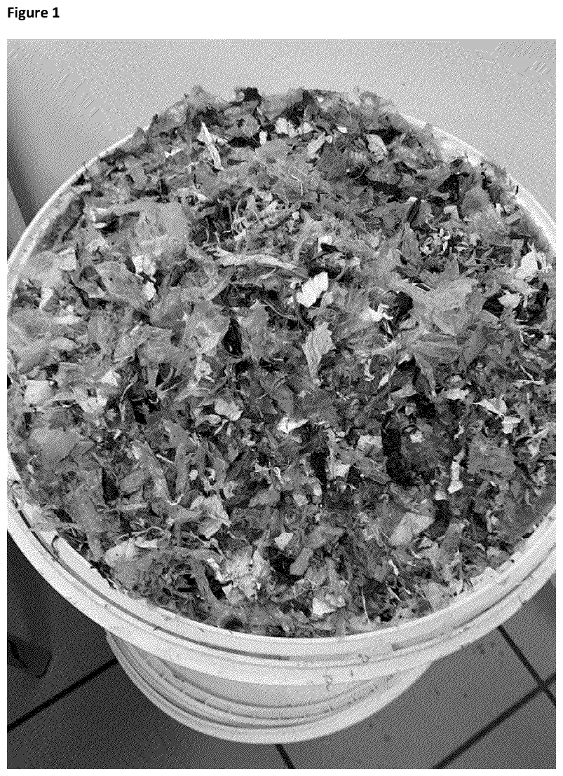

FIG. 1 is an image of a first plastic feed used in pyrolysis;

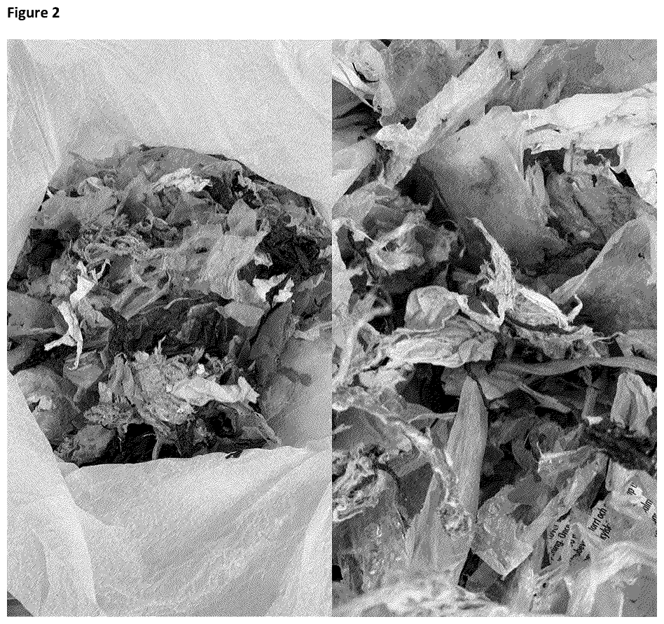

FIG. 2 is an image of a second plastic feed used in pyrolysis;

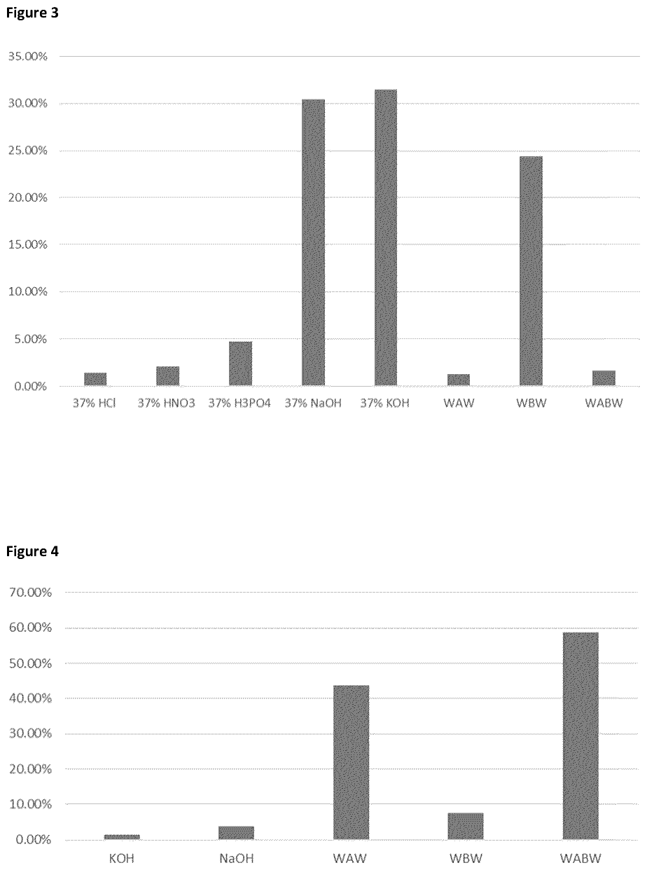

FIG. 3 illustrates the percentage increase in carbon content of plastic pyrolytic char following washing under various conditions; and

FIG. 4 demonstrates the ash content of plastic pyrolytic char following washing under various conditions.

### EXAMPLES

### Example 1—Pyrolysis

Crude plastic pyrolytic char (referred to as ‘crude char’ below) used in the following examples was obtained from Vadxx, Ohio using the following method.

Examples of plastic feed materials comprising about 85 wt % PP and PE used in pyrolysis are shown in FIGS. 1 and 2. These feed materials were extruded and chopped prior to pyrolysis.

400 g of the extruded and chopped plastic feed was pyrolyzed in a fixed bed reactor at a temperature of 450 to 600° C.

This experiment was performed twice using plastic feeds provided in different forms, as shown in FIG. 1 and FIG. 2. As can be seen, the plastic feed in FIG. 1 is more finely shredded than that in FIG. 2 The feedstock shown in FIG. 1 was used in Reaction 1 and the feedstock shown in FIG. 2 was used in Reaction 2. The ratios of the products of these reactions are described in Table 1.

TABLE 1

| Yield (wt %) | Reaction 1 | Reaction 2 |
|---|---|---|
| Char | 8 | 11 |
| Liquid | 61 | 57 |
| Gas | 31 | 32 |

This demonstrates that acceptable char yields may be obtained by pyrolysis of a plastic feed for use in the following washing process.

The crude char was separated from the other products and used in the following process.

### Example 2—Acid Washing (AW)

1. 1 g of crude char was weighed;
2. Acid four times the char's weight was added to the crude char;
3. The acid-char mixture was heated at 100° C. and stirred with a magnetic stirrer at 400 rpm for 1 hour;
4. After 1 hour, the char was removed from heat source and left too cool at room temperature;
5. Cooled char samples were filtered and washed with 100 mL of distilled water;
6. Filtered chars were dried in an oven overnight.

This process was performed using the following acids:
a. 37 wt % hydrochloric acid solution in water (HCl)
b. 37 wt % phosphoric acid solution in water (H₃PO₄)
c. 37 wt % nitric acid solution in water (HNO₃)

The samples were submitted for metal content analysis using Flame Atomic Adsorption Spectrometry (FAAS) using a Perkin Elmer Analyst 100. A maximum temperature of 2600° C. was used. The results are shown below in Table 2 below.

TABLE 2

| mg/kg | Crude char | | | |
|---|---|---|---|---|
| (ppm) | (FAAS) | HCl | HNO₃ | H₃PO₄ |
| Al | 34277.3 | 1286.7 | 10847.1 | 17895.1 |
| As | <25 | <25 | <25 | <25 |
| B | 47.2 | <25 | <25 | <25 |
| Ba | 207.7 | 40.9 | 31.7 | 86.4 |
| Ca | 235185.5 | 3314.9 | 1924.9 | 8706.9 |
| Cd | <25 | <25 | <25 | <25 |
| Co | <25 | <25 | <25 | <25 |
| Cr | 50.1 | <25 | <25 | <25 |
| Cu | 104 | 19 | <25 | 167.3 |
| Fe | 1331.9 | 94.8 | 218 | 542.7 |
| K | 159.6 | 25.9 | 41.1 | 226.9 |
| Mg | 7219.4 | 262.7 | 430.3 | 1459.6 |
| Mn | 53.2 | <25 | <25 | <25 |
| Mo | | <25 | <25 | <25 |
| Na | 210.1 | 38.6 | 38 | 180 |
| Ni | 25.6 | <25 | <25 | <25 |
| P | 180.5 | 351.5 | 322.1 | 7077.3 |
| Pb | 189.9 | 884 | 290.4 | 3306.4 |
| Sb | 6521.1 | 5329 | 3165.9 | 2016.4 |
| Se | <25 | <25 | <25 | <25 |
| Si | 7015.4 | 1630.4 | 1147 | 1924.7 |
| Sn | 60.5 | <25 | <25 | <25 |
| Sr | 108.8 | <25 | <25 | <25 |
| Ti | 14024.2 | 1091.1 | 1773.9 | 458.7 |
| V | <25 | <25 | <25 | <25 |
| Zr | 185 | 65.3 | 425.8 | 2730 |
| Total content | 307157 | 14434.8 | 20656.2 | 46778.4 |

In order to calculate the ash content, it was assumed that the metals detected by the FAAS method makes up 100% of the ash content present in the plastic pyrolysis char sample. Thus, the ash content in terms of weight percentage make-up of the char sample from the metal analysis results in Table 2 was calculated. These results are shown in FIG. 3.

The most effective acid for removing ash and metal contaminants is HCl. Therefore, this was used to further investigate the effect of pre-washing.

### Example 3—Base Washing (BW)

1. 1 g of crude char was weighed;
2. Base four times the char's weight was added to the crude char;
3. The acid-char mixture was heated at 100° C. and stirred with a magnetic stirrer at 400 rpm for 1 hour;
4. After 1 hour, the char was removed from heat source and left too cool at room temperature;
5. Cooled char samples were filtered and washed with 100 mL of distilled water;
6. Filtered chars were dried in an oven overnight.

This process was performed using the following bases:
a. 37 wt % potassium hydroxide solution in water (KOH)
b. 37 wt % sodium hydroxide solution in water (NaOH)

The carbon content of the samples was analysed using standard methods. The results are shown below in Table 3 and the percentage increase in carbon content is shown in FIG. 4.

TABLE 3

| Sample | Carbon content (wt %) |
|---|---|
| Crude Char | 28.63% |
| KOH | 30.03% |
| NaOH | 32.39% |

The metal content of the samples was analysed using the method described in Example 2. The results are shown below in Table 4 below.

TABLE 4

| mg/kg | Crude char | | |
|---|---|---|---|
| (ppm) | (FAAS) | NaOH | KOH |
| Al | 34277.3 | 27706 | 37809.3 |
| As | <25 | <14 | <25 |
| B | 47.2 | 24.3 | 72.7 |
| Ba | 207.7 | 197.1 | 149.2 |
| Ca | 235185.5 | 234425.9 | 235185.5* |
| Cd | <25 | <14 | <25 |
| Co | <25 | 17.7 | <25 |
| Cr | 50.1 | 38.8 | 39.5 |
| Cu | 104 | 120.3 | 121.3 |
| Fe | 1331.9 | 1212 | 1358.2 |
| K | 159.6 | 183.8 | 545.5 |
| Mg | 7219.4 | 7266.1 | 7352 |
| Mn | 53.2 | 45.4 | 45.9 |
| Mo | | | |
| Na | 210.1 | 3223.2 | 186.9 |
| Ni | 25.6 | 21.4 | <25 |
| P | 180.5 | 152.6 | 174 |
| Pb | 189.9 | 3018.1 | 1876.5 |
| Sb | 6521.1 | 4802.2 | 6324.3 |
| Se | <25 | <14 | <25 |
| Si | 7015.4 | 6410.4 | 6785.1 |
| Sn | 60.5 | 45.2 | 53.6 |
| Sr | 108.8 | 109.2 | 62.8 |
| Ti | 14024.2 | 11293.4 | 12156.1 |
| V | <25 | 16.2 | 25 |
| Zn | 185 | 3973.6 | 4188.6 |
| Total content | 307157 | 304302.9 | 314512 |

*The calcium content detected in the KOH treated was reported to be 2,133,334 mg/kg.

This is around ten times the concentration of calcium detected in the crude char sample, which has a concentration of 235,185 mg/kg. Therefore, this value has been treated as an outlier and it has been assumed that the calcium content present in the KOH sample does not change from the amount present in crude char the above analysis.

The ash content was determined as described in Example 2 using the results in Table 4. These results are shown in FIG. 3.

The greater increase in carbon content and reduction in metal content and ash content observed for NaOH treated samples when compared to KOH is believed to be due to the higher base dissociation constant of the NaOH (0.631), which is about twice the dissociative constant of KOH (0.316).

Due to the better results obtained using NaOH, this base was used in the further investigations below.

### Example 4— Pre-Washing+Acid or Base Washing (WAW or WBW)

### Pre-Washing:

1. 1 g char samples were weighed;
2. Distilled water was added to the crude char and stirred with a magnetic stirrer at 400 rpm in room temperature for 1 hour;
3. Washed char was filtered from the distilled water;
4. The filtered char dried in an oven to dry overnight.

This pre-washed char was then:
a. acid washed with 37 wt % hydrochloric acid as described in Example 2 (WAW); or
b. base washed with 37 wt % sodium hydroxide as described in Example 3 (WBW).

Agglomeration of char particles to form coarser particle sizes was observed following pre-washing.

The carbon content of the samples was analysed using the same method as Example 3. The results are shown below in Table 5 and the percentage increase in carbon content is shown in FIG. 4.

TABLE 5

| Sample | Carbon content (wt %) |
|---|---|
| Crude Char | 28.63% |
| WAW | 72.33% |
| WBW | 36.11% |

The metal content of the samples was analysed using the method described in Example 2. The results are shown below in Table 6 below.

TABLE 6

| mg/kg (ppm) | WAW | WBW |
|---|---|---|
| Al | 1319.2 | 39967.7 |
| As | <40 | <25 |
| B | <40 | 28.1 |
| Ba | 63 | 95.2 |
| Ca | 4393.8 | 154873.4 |
| Cd | <40 | <25 |
| Co | <40 | <25 |
| Cr | <40 | 51.3 |
| Cu | <40 | 140.2 |
| Fe | 174 | 1852.2 |
| K | 125.9 | 201.3 |
| Mg | 329.5 | 9930.5 |
| Mn | <40 | 59.1 |
| Mo | | |
| Na | 86 | 2928 |
| Ni | <40 | 31.5 |
| P | 112.5 | 207.5 |
| Pb | 1101.7 | 3160.2 |
| Sb | 2813.4 | 6248.2 |
| Se | <40 | <25 |
| Si | 1738.2 | 4981.3 |
| Sn | <40 | 61.6 |
| Sr | <40 | 39.2 |
| Ti | 497.1 | 14048.9 |
| V | <40 | 28.2 |
| Zn | 159.6 | 5144.4 |
| Total content | 12913.9 | 244078 |

The ash content was determined as described in Example 2 using the results in Table 6. These results are shown in FIG. 3.

These results demonstrate the benefit of pre-washing when compared to acid washing or base washing alone.

### Example 5— Pre-Washing+Acid and Base Washing (WABW)

Pre-washing was performed as described in Example 4;
1. The pre-washed and dried char sample was weighed;
2. 37 wt % hydrochloric acid four times the char's weight was added to the crude char;
3. The acid-char mixture was heated at 100° C. and stirred with a magnetic stirrer at 400 rpm for 1 hour;
4. After 1 hour, the char was removed from heat source and left too cool at room temperature;
5. Distilled water was added to the cooled char, the mixture spun in a centrifuge at 3.5 thousand rpm for 4 minutes to settle the char from the distilled water and the distilled water removed from the settled char; and
6. The procedure of steps 2 to 5 was repeated with a 37 wt % sodium hydroxide solution.

Agglomeration of char particles to form coarser particle sizes was observed following pre-washing.

The carbon content of the samples was analysed using the same method as Example 3. The results are shown below in Table 7 and the percentage increase in carbon content is shown in FIG. 4.

TABLE 7

| Sample | Carbon content (wt %) |
|---|---|
| Crude Char | 28.63% |
| WABW | 87.17% |

The metal content of the samples was analysed using the method described in Example 2. The results are shown below in Table 8 below.

TABLE 8

| mg/kg (ppm) | Crude char (FAAS) | WABW |
|---|---|---|
| A | 34277.3 | 1860.4 |
| As | <25 | <125 |
| B | 47.2 | <125 |
| Ba | 207.7 | <125 |
| Ca | 235185.5 | 5659.2 |
| Cd | <25 | <125 |
| Co | <25 | <125 |
| Cr | 50.1 | <125 |
| Cu | 104 | <125 |
| Fe | 1331.9 | 314.9 |
| K | 159.6 | 343.6 |
| Mg | 7219.4 | 925.1 |
| Mn | 53.2 | <125 |
| Mo | | |
| Na | 210.1 | 526.1 |
| Ni | 25.6 | <125 |
| P | 180.5 | <125 |
| Pb | 189.9 | 733.9 |
| Sb | 6521.1 | 862 |
| Se | <25 | <125 |
| Si | 7015.4 | 2160.3 |
| Sn | 60.5 | <125 |
| Sr | 108.8 | <125 |
| Ti | 14024.2 | 3213.3 |
| V | <25 | <125 |
| Zn | 185 | 185 |
| Total content | 307157 | 16783.8 |

The ash content was determined as described in Example 2 using the results in Table 8. These results are shown in FIG. 3.

These results demonstrate that the carbon content of carbon black produced using the WABW washing procedure in Example 5 is significantly higher than other washing methods. Moreover, the metal content and ash content are low and significantly reduced when compared to crude char. Both the carbon content and the ash content are acceptable levels for use in many carbon black applications. Thus, samples prepared using the WABW method may be used to replace alternative carbon black sources, such as those traditionally produced using less environmentally friendly processes. By comparison, samples prepared using alternative washing methods did not successfully both increase carbon content and remove metal contaminants.

These results demonstrate that mild conditions and simple procedures may be used in the production of carbon black from plastic pyrolytic char which has both high carbon content and low ash content.

1. A process for producing carbon black, comprising:
a) pyrolising a plastic feed comprising polyethene (PE), polypropylene (PP), or combination thereof, to produce a plastic pyrolytic char;
b) pre-washing the plastic pyrolytic char with an aqueous solution (such as water);
c) washing the pre-washed plastic pyrolytic char with acid; and
d) washing the acid-washed plastic pyrolytic char with base.

2. The process according to claim 1, wherein the plastic feed comprises less than 20 wt %, preferably less than 10 wt %, more preferably less than 5 wt % and even more preferably is substantially free from carbon black.

3. The process according to claim 1, wherein at least 50 wt %, preferably at least 60 wt %, more preferably at least 70 wt % of the plastic feed is made up of PE (such as high-density polyethylene (HDPE) or low-density polyethylene (LDPE)) and/or PP.

4. The process according to any of claims 1 to 3, wherein the plastic feed comprises less than 0.1 wt %, preferably less than 0.07 wt %, more preferably less than 0.05 wt % polyvinyl chloride (PVC).

5. The process according to any of claims 1 to 4, wherein pre-washing in step b) is performed at a temperature of from 5 to 50° C., preferably from 10 to 40° C., more preferably from 15 to 30° C.

6. The process according to any of claims 1 to 5, wherein pre-washing in step b) is performed for a duration of 10 minutes to 3 hours, preferably 30 minutes to 2 hours, more preferably 45 minutes to 1.5 hours.

7. The process according to any of claims 1 to 6, wherein the acid is selected from HCl, HNO₃, H₃PO₄ and mixtures thereof, preferably HCl.

8. The process according to any of claims 1 to 7, wherein the weight ratio of acid to pre-washed plastic pyrolytic char used in step c) is from 0.1:1 to 4:1, preferably 0.5:1 to 3:1, more preferably 1:1 to 2:1.

9. The process according to any of claims 1 to 8, wherein washing in step c) is performed at a temperature of from 30 to 150° C., preferably from 60 to 130° C., more preferably from 90 to 110° C.

10. The process according to any of claims 1 to 9, wherein washing in step c) is performed for a duration of 10 minutes to 3 hours, preferably 30 minutes to 2 hours, more preferably 45 minutes to 1.5 hours.

11. The process according to any of claims 1 to 10, wherein step c) further comprises washing the acid-washed plastic pyrolytic char with water.

12. The process according to any of claims 1 to 11, wherein the base is selected from KOH, NaOH and mixtures thereof, preferably NaOH.

13. The process according to any of claims 1 to 12, wherein the weight ratio of base to acid-washed plastic pyrolytic char used in step d) is from 0.1:1 to 4:1, preferably 0.5:1 to 3:1, more preferably 1:1 to 2:1.

14. The process according to any of claims 1 to 13, wherein washing in step d) is performed at a temperature of from 30 to 150° C., preferably from 60 to 130° C., more preferably from 90 to 110° C.

15. The process according to any of claims 1 to 14, wherein washing in step d) is performed for a duration of 10 minutes to 3 hours, preferably 30 minutes to 2 hours, more preferably 45 minutes to 1.5 hours.

16. The process according to any of claims 1 to 15, wherein step d) further comprises washing the base-washed plastic pyrolytic char with water.

17. The process according to any of claims 1 to 16, further comprising reducing the particle size of the plastic pyrolytic char following pre-washing in step b) and/or following acid washing in step c) and/or following base washing in step d), preferably by grinding.

18. The process according to any of claims 1 to 17, wherein the carbon black comprises at least 70 wt. % carbon, preferably at least 75 wt. % carbon, more preferably at least 80 wt. % carbon and even more preferably at least 85 wt. % carbon.

19. The process according to any of claims 1 to 18, wherein the carbon black has a total metal content of below 50,000 mg/kg, preferably below 20,000 mg/kg, more preferably below 15,000 mg/kg.

20. The process according to any of claims 1 to 19, wherein the carbon black has an ash content below 5 wt. %, preferably below 3 wt. %, more preferably below 1 wt. % and even more preferably below 0.5%.

21. The process according to any of claims 1 to 20, wherein the carbon black has a surface area of from 20 to 200 m²/g, preferably from 40 to 150 m²/g, more preferably from 60 to 100 m²/g

22. The process according to any of claims 1 to 21, wherein the carbon black has a pore volume of at least 0.06 cm³/g, preferably at least 0.9 cm³/g, more preferably at least 0.13 cm³/g, even more preferably at least 0.16 cm³/g.

23. Use of a feed comprising PP, PE or combinations thereof in the production of carbon black.

24. Use of pyrolytic char formed from PP, PE, or combinations thereof in the production of carbon black.
